(19) United States
(12) Patent Application Publication
(10) Pub. No.: US 2025/0264724 A1
(43) Pub. Date: Aug. 21, 2025

(54) Augmented reality system for a swimming pool

(71) Applicants: Emanuele SALVINELLI, Ginevra (CH); Fabrizio SALVINELLI, Roma RM (IT)

(72) Inventors: Emanuele SALVINELLI, Ginevra (CH); Fabrizio SALVINELLI, Roma RM (IT)

(21) Appl. No.: 19/058,322

(22) Filed: Feb. 20, 2025

(30) Foreign Application Priority Data
Feb. 21, 2024 (IT) 102024000003589

(51) Int. Cl. G02B 27/01; G01P 1/08

(52) U.S. Cl. CPC G02B 27/0172; G01P 1/08

(57) ABSTRACT

An augmented reality system for applications in competitive sport or in the recreational or leisure sector, in a swimming pool is provided. The system includes means of visual input arranged within the swimming pool on the bottom and/or wall(s) and/or ceiling possibly of varying height, to present underwater images to a subject moving within the pool and a control unit arranged outside the swimming pool to control the visual input means so as to present a dynamic virtual scenario to the subject.

### TECHNICAL FIELD OF THE INVENTION

The present invention relates to an augmented reality system, based primarily on visual input, configured for use within, or in association with, a swimming pool.

### BACKGROUND

Augmented reality systems for recreational and/or training purposes are very widespread in the art. A simple example is that of treadmills and exercise bikes instrumented with displays that show, for example, speed data and/or fictitious, naturalistic or urban environments that are presented to the subject as if he or she were riding them.

The Inventors have noted that systems of similar effectiveness and, often, utility, are not associated with an aquatic environment, in particular a swimming pool or pool.

In contrast, in competitive swimming, it is very difficult to communicate to the athlete his or her performance data in real time, in particular during a training session or competition. The Inventors have noted that an appropriately configured augmented reality system can make an important contribution to overcoming this drawback, allowing effective communication in an aquatic environment and thus contributing to an important extent to improving the performance of athletes.

### SUMMARY OF THE INVENTION

The technical problem posed and solved by the present invention is, therefore, to provide a system allowing to overcome the drawbacks and meet the above-mentioned needs with reference to the known art.

Such problem is solved by an augmented reality system according to claim 1.

Preferred features of the present invention are the subject of dependent claims.

In the present context, “augmented reality” means an artificial expansion of the subject's perceptions in the swimming pool by means of externally controlled inputs, in particular of the visual type.

In one of its embodiments, the present invention provides a system for creating images and/or sequences of images on the walls of a swimming pool, including the floor, for example, to give swimmers a visual indication of the speed they want to reach or maintain.

The system, in its embodiment variants, also lends itself to leisure and/or recreational applications, such as providing exciting activities in a virtual environment reproduced within the pool.

Other advantages, features and use modes the present invention will result evident from the following detailed description of some embodiments, presented by way of example and not for limitative purposes.

### BRIEF DESCRIPTION OF THE FIGURES

The figures of the enclosed drawings will be referred to, wherein:

FIG. 1 shows a schematic representation, in a top view, of part of a swimming pool that comprises a system according to a first preferred embodiment of the present invention;

FIG. 2 shows a schematic representation, in a top view, of part of a swimming pool that comprises a system according to a second preferred embodiment of the present invention;

FIG. 3 shows a schematic representation, in a top view, of part of a swimming pool that comprises a system according to a third preferred embodiment of the present invention;

FIG. 4 shows a schematic representation, in a top view, of part of a swimming pool that comprises a system according to a fourth preferred embodiment of the present invention;

FIG. 5 shows a schematic representation, in a top view, of part of a swimming pool that comprises a system according to a fifth preferred embodiment of the present invention; and

FIG. 6 shows a block diagram of an embodiment of the system according to the invention, compatible with the systems of each of the previous figures.

### DETAILED DESCRIPTION OF PREFERRED EMBODIMENTS

Various embodiments and variants of the invention will be described hereinafter, with reference to the figures introduced above.

Similar components are denoted in the different figures with the same numerical reference.

In the following detailed description, further embodiments and variants with respect to embodiments and variants already dealt with in the same description will be illustrated limited to the differences with what has already been explained.

Moreover, the different embodiments and variants described hereinafter are capable of being used in combination.

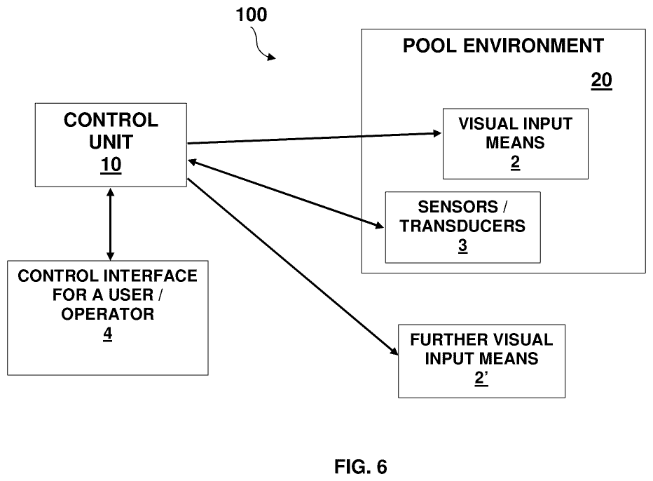

FIG. 6 shows a general block diagram of one embodiment of the augmented reality system of the invention, denoted herein as a whole by 100.

The system 100 is for use in a swimming pool, or pool, 20.

The system 100 comprises primarily visual input means 2 configured to be arranged within the swimming pool 20 and to provide an underwater and dynamic visual input to a subject swimming, or positioned, within that pool. The dynamic visual input may comprise images, including alphanumeric characters, and/or light sequences.

Advantageously, in a competitive swimming training application, such visual input may be representative of a speed detected and/or desired for the swimming subject. To this end, the system 100 may comprise detection means 3 of a speed of movement, configured to detect the speed of the subject swimming in the pool 20. Such means 3 typically comprise sensors and/or transducers, possibly wearable or carriable on the body of the swimming subject.

The visual input means 2 are configured to project or provide a visual input at the bottom walls and/or side walls of the swimming pool 20, according to embodiment variants that will be described shortly with reference to other figures as well.

The visual input means 2 may comprise one or more of the following elements: display, screen, LED, lights, neon, projector.

Further visual input means 2′ may be placed outside the pool environment, such as on the ceiling of the structure that houses the pool or in any case in elevation relative to the pool 20, so as to be visible, for example, during backstroke swim.

The system 100 thus comprises a control unit 10, configured generally to be arranged externally to the swimming pool 20 and to control the visual input means 2, 2′ possibly according to a speed detected by the detection means 3. The control unit 10 may be implemented by hardware and software means well known in the art, for example in the form of a computer, processor, smart phone or other. The control unit is connected to the other components of the system by wireless, Bluetooth, wi-fi, or other.

The system 100 may also comprise a control interface 4 for an operator, in communication with said control unit 10, for example, to select the type of visual input to be provided to the subject.

The system 100 may also comprise, or be employed in conjunction with, a viewer wearable by the subject in the pool 20. The viewer may cooperate with the visual input means 2, 2′ to present the dynamic visual input to the subject.

Some embodiment variants will now be presented, which refer primarily to an application of the system 100 for the competitive training of a swimmer.

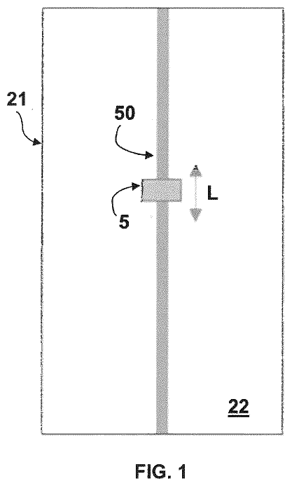

With reference to FIG. 1, in a first embodiment variant, the visual input means introduced above are configured to provide the dynamic visual input at the bottom 22 of the pool 20. Such input is presented according to a longitudinal direction L corresponding to the length of a lane 21.

In particular, in the present example, the system 100 comprises a supporting structure 5, or skid, sliding according to the direction L on a guide 50 installed at the bottom 22 of pool 20. The guide 50 may also be made in the form of a flat metal strip.

The supporting structure 5, for example substantially in the form of a pedestal, carries the visual input means 2 or part thereof. Such means 2 may herein consist of a light, screen or static image. The movement of the support 5 may be controlled by the control unit 10 according to the actual or desired speed of the swimmer.

As mentioned, the visual input provided—for example, in the form of images, colour of a screen, or otherwise—may be adjusted by the control unit 10. Such adjustment may be automatic, for example, based on predetermined training programs and/or performance targets, or associated with a command from an operator via the interface 4, the latter, for example, in the form of a remote control or application on a smart phone or similar.

The above-mentioned adjustments of speed and visual input may also be carried out by the swimmer himself or herself.

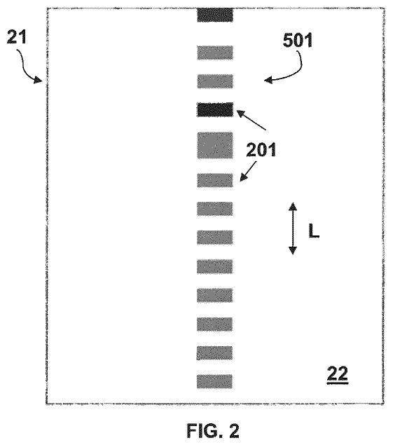

With reference to FIG. 2, in a second embodiment variant there is a support 501 installed on the bottom 22 of a lane 21 and carrying visual input means, denoted herein by 201, configured to provide sequential light input along the longitudinal direction L, the input being in particular dependent on the position and/or speed of the swimming subject. The lights may possibly turn on in a sequential and progressive manner for the two directions of travel, on the two long sides of the lane(s) to indicate forward and return, with a progression speed, for example programmed to try to maintain, equal or possibly exceed it over various distances. For example, to break provincial, regional, national, world or specific swimmers' records. This will allow all swimmers, the forms of comparison that they or their coaches want to programme.

The support 501 may also in this case be in the form of a flat strip. The visual input means 201 may comprise lights, lamps, LEDs, screens, multimedia devices in general or other. They may be controlled as already illustrated in the previous variant—that is, by means of the control unit 10, either automatically or upon input from an operator—so as to turn on and/or off, change colour and/or present different images, in particular according to a training program or performance target.

In the embodiments and embodiment variants presented herein, the visual input means may be configured to provide the dynamic visual input in a variable manner according to the direction of travel of the lane 21 and/or the specific swimming subject.

For example, in the embodiment of FIG. 2, two lines of lights and/or LED screens may be provided, on the two long sides of the lane(s), such that the forward and return of the swimmer, or of multiple swimmers present in the same lane 21, may be indicated separately.

Moreover, elements of interactive activities may be included in the visual input for recreational purposes, such as a virtual environment with a pod of turtles in the coral reef.

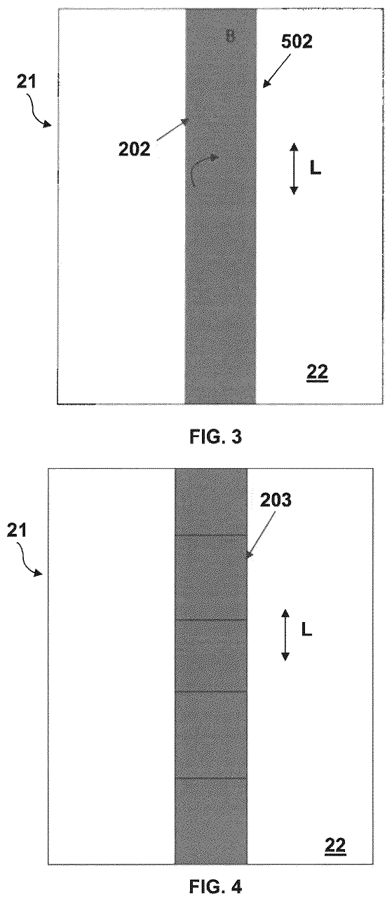

In a third embodiment variant exemplified in FIG. 3, the visual input means, denoted herein by 202, comprise lamps, screens, LEDs, or other arranged in sequence on a support 502, also possibly in the form of a strip, on one or more lanes, or visual input means arranged on the entire bottom and/or side walls of the swimming pool.

Also in the case, a sequential activation may be provided, and the description already proposed in relation to the previous two variants in FIGS. 1 and 2 applies herein.

For example, the visual input may comprise a dolphin swimming back and forth with the swimmer, possibly at an adjustable speed to provide the swimmer with an indication of the desired speed.

In embodiment variants, in each lane there are signals running from the beginning to the end and then back again (e.g., a dolphin or champion swimmer) to follow a single swimmer. In the case of multiple swimmers, in order not to have overlapping, the signal will follow a longitudinal pattern specific to each swimmer and the direction of travel, for example to the right of the lane on both the forward and return leg.

According to a fourth embodiment variant shown in FIG. 4, the visual input means, denoted herein by 203, comprise a screen or several multimedia screens installed on the bottom 22 of the lane 21 and/or on the entire surface of the bottom and/or side walls.

The same description provided above for the other variants also applies to this embodiment variant.

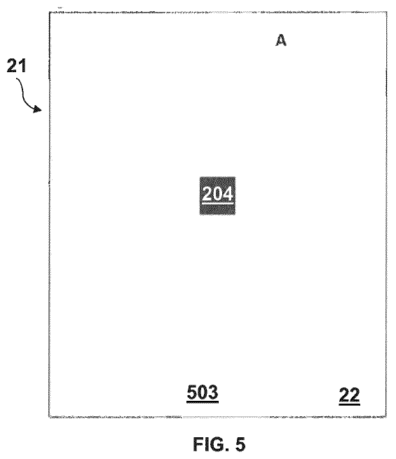

In a fifth embodiment variant shown in FIG. 5, the visual input means, denoted herein by 204, comprise a projector installed on the bottom 22 of the lane 21 and/or two or more lanes, adapted to project visual input onto the bottom of each lane and/or the entire floor and/or onto one, more, or all the walls. Also in this case a support, denoted herein by 503, may be provided, for example in the form of a strip.

The same description provided above for the other variants also applies to this embodiment variant.

According to a further embodiment variant, visual input means may create interactive games coordinated by the swimmer (who becomes the player in this case), which may also involve a plurality of swimmers, such that the latter may play together in interactive group activities. Some possible implementations are discussed hereinafter.

The swimmer has a motion sensor on him or her (e.g., attached to the swim cap, swimsuit, or via a belt or glove(s)) that allows him or her to interact in the virtual game flowing on the screens or multimedia modules in the pool (e.g., in the lane below him or her). For example, the swimmer must chase and catch a second character flowing on the screens, and/or must move to avoid obstacles by swimming right/left or underwater. Based on his or her swimming speed and/or direction, the first character of the game (which represents the player) moves on the screens toward the second character(s) or toward any image(s). The characters, speed and type of game may be set via the control unit.

When swimming, one may make use of a laser device arranged over the index finger and controlled by a button that is pressed by the thumb. One can thus play video games, such as shooting at moving targets, represented, for example, in the form of flying saucers, submarines, sharks or other.

Moreover, video games may be arranged that users may get to play in the pool alone or with their friends and personalise their experience. These video games are, for example, loadable onto the control unit, in the form of a computer, which controls the visual input means in one or more lanes.

The control unit, possibly also in the form of a remote control or laptop, may allow, via the user interface, to choose, change, and set the interactive games for a part (e.g., a lane) or for the entire pool. As already specified, the control unit may be connected to the other components via wireless, Bluetooth, wi-fi, or other.

As mentioned above, in a variant embodiment, it is possible to complement the visual input means in the pool with further ceiling means, possibly mounted on a vertically movable support that may approach the free surface of the water. In this manner the user, in recreational applications, may see reproduced, for example, a sky above the pool, or imagine being immersed in the sea, in three dimensions.

In general, the system of the invention may allow full immersion in a virtual aquatic environment, due to the presence of a plurality of screens arranged on all the walls of the pool and also above it.

According to a further embodiment variant, it is also possible to carry out swimming competitions amongst people from all over the world, in virtual reality, with a synchronised starting for the participants, saving travel costs, and allowing swimmers to see, via the visual input means in each pool, the positions of the other competitors.

The present invention has thus far been described with reference to preferred embodiments and embodiment variants whose features, as already mentioned, are usable in combination.

It is to be understood that other embodiments belonging to the same inventive core may exist, as defined by the scope of protection of the claims reported hereinafter.

1. An augmented reality system configured for use within a swimming pool, wherein the system comprises:
visual input means, configured to be arranged within the swimming pool to provide an underwater dynamic visual input to a subject swimming within said swimming pool, said dynamic visual input comprising images or light sequences that can move or light up according to a programmable speed;
a detector of a speed of movement, configured to detect the speed of the subject swimming in the pool; and
a control unit, configured to control said visual input means according to a speed detected by said detector,
wherein said visual input means is representative of a speed detected and/or desired and/or to be equaled or exceeded by said swimming subject and with which speed the subject can compare.

2. The system according to claim 1, wherein said visual input means are configured to project or provide a visual input at bottom walls and/or side walls of the swimming pool.

3. The system according to claim 1, wherein said visual input means are configured to provide said dynamic visual input at the bottom of the swimming pool according to a longitudinal direction corresponding to the length of a lane.

4. The system according to claim 3, wherein said visual input means are configured to provide a sequential light input along said longitudinal direction depending on the position of the swimming subject.

5. The system according to claim 4, wherein said visual input means are configured to provide said dynamic visual input in a variable manner depending on the direction of travel in the lane and/or the specific swimming subject.

6. The system according to claim 5, wherein said visual input means are configured in each lane in the forward part and in the return part, according to two lines of lights and/or screens, so as to be able to separately indicate the forward and return of the swimmer, or of several swimmers present in the same lane and to provide them with speed indications.

7. The system according to claim 1, wherein said visual input means comprise one or more of the following elements: display, screen, LED, lights, neon, projector.

8. The system according to claim 1, wherein said control unit is configured to be arranged externally to the swimming pool.

9. The system according to claim 1, wherein said detector comprises one or more sensors and/or transducers.

10. The system according to claim 1, wherein said detector is wearable or carriable on the body of the swimming subject.

11. The system according to claim 1, comprising a control interface for an operator, in communication with said control unit.

12. The system according to claim 1, comprising a supporting structure sliding on a guide installable at the bottom of the swimming pool according to a longitudinal direction corresponding to the length of a lane, said supporting structure bearing said visual input means or part thereof.

13. The system according to claim 1, comprising a visor wearable by the swimming subject and cooperating with said visual input means to present to the swimming subject said dynamic visual input means.

14. The system according to claim 1, comprising further visual input means installed or installable in elevation relative to the swimming pool, possibly on a screen or stand, at a variable height adjustable and selectable over the swimming pool.

15. An augmented reality system configured for use in a swimming pool wherein the system comprises:
visual input means, configured to be arranged within the swimming pool, on the bottom and/or on one or more or all of the walls, to present underwater images to a subject positioned within said pool; and
a control unit, configured to control said visual input means so as to present a dynamic virtual scenario to the subject.

16. The system according to claim 1, comprising further visual input means installed or installable in elevation with respect to the swimming pool, optionally on a screen or support, at a variable height adjustable and selectable over the swimming pool.

17. An assembly comprising a swimming pool and an augmented reality system according to claim 1 installed or installable in said swimming pool.

18. The system according to claim 15, comprising further visual input means installed or installable in elevation with respect to the swimming pool, optionally on a screen or support, at a variable height adjustable and selectable over the swimming pool.

19. An assembly comprising a swimming pool and an augmented reality system according to claim 15 installed or installable in said swimming pool.
